(19) United States
(12) Patent Application Publication
(10) Pub. No.: US 2006/0000194 A1
(43) Pub. Date: Jan. 5, 2006

(54) Electronic animal training device support system

(76) Inventors: Timothy T. Duncan, Tucson, AZ (US); Stephen M. Myers, Tucson, AZ (US)

Correspondence Address: Cahill, von Hellens & Glazer P.L.C., 155 Park One, 2141 E. Highland Avenue, Phoenix, AZ, 85016, US

(21) Appl. No.: 10/883,547

(22) Filed: Jul. 1, 2004

(51) Int. Cl. B68B 1/00; A01K 27/00

(52) U.S. Cl. 54/71; 119/859

(57) ABSTRACT

An animal training apparatus including an collar-supported electronic device having stimulus electrodes extending therefrom and a partially elastic collar for holding the electronic device so as to press conductive tips of the stimulus electrodes against a neck of the animal. The partially elastic collar includes a non-elastic strap section having a free first end and a second end, an elastic strap section having a first end attached to the second end of the non-elastic strap section and a second end attached to a buckle. The elastic strap section stretches to accommodate changes in the circumference of the neck so as to maintain at least a minimum tensile force in the collar as the circumference of the neck varies from a minimum to a maximum value as result of normal movement of the animal's head to thereby maintain the position of the electronic device against the neck.

### BACKGROUND OF THE INVENTION

The present invention relates generally to collar-mounted electronic animal stimulation and/or sensing devices, and more particularly to improved collars for mounting animal training devices on the necks of animals, such as horses. The invention also relates generally to techniques for substantially reducing or eliminating equine “vices”, such as cribbing behavior of a horse.

The closest prior art is believed to be the assignee's VICEBREAKER H1 Equine Remote Trainer product including a collar-supported receiver unit 4 mounted as shown in FIG. 1B.

In the prior art system of mounting the electronic receiver unit 4 as shown in FIG. 1B, a leather collar strap 5 is used and extends around the horse's neck. In the embodiment of the present invention chosen for illustration as shown in FIG. 1A, a leather collar strap 5 extends through loops 7 of receiver unit 4 and attaches to an elastic strap section 12 in manner to be described and extends around the neck of the horse to support receiver unit 4 generally as illustrated in FIG. 2. Equine remote trainer 1 includes a remote transmitter 2 including two switch buttons 2A and 2B that can be depressed by a user. One of the switch buttons, when depressed, remotely causes an audible signal to be produced by a collar-supported electronic receiver unit 4 mounted on the neck of a horse. The other switch button, when depressed, remotely causes an aversive electronic stimulus to be produced between the two electrodes 6 of receiver unit 4. A rotary switch 2C on transmitter unit 2 can be rotated by the user to select the desired intensity of the aversive stimulus to be applied to skin on the side of the neck of the horse through electrodes 6. Transmitter 2 and receiver unit 4 are generally as described in commonly assigned U.S. Pat. No. 6,549,133, entitled “Remote Transmitter and Method”, issued to Duncan et al. on Apr. 15, 2003. The equine remote trainer 1 is used for reducing or eliminating equine “vices” such as cribbing behavior by horses. (The system as described in above mentioned U.S. Pat. No. 6,549,133 is utilized primarily for training dogs, but the transmitter and receiver unit described therein, with minor modification to the range of aversive stimulus intensity levels produced by the receiver unit, are used in the assignee's above-mentioned prior art VICEBREAKER H1.)

The above mentioned equine cribbing behavior is a fairly common but highly undesirable equine activity that is harmful to the horse and also to the stable property and therefore usually needs to be corrected. The causes of such behavior may include boredom, learned behavior and genetics. U.S. Pat. No. 5,722,352 (Leatherman) describes cribbing behavior, and an electronic device for reducing cribbing behavior.

Collars used to support the receiver units of prior electronic animal training systems both for training dogs and for training horses generally are not made of elastic material. One reason for this is that elastic material generally is not nearly as durable as non-elastic material, and this has been an important consideration in the design of prior electronic unit support collars because dogs, especially hunting dogs which are trained with electronic training devices, generally are very rough on most electronic dog training devices. A receiver collar composed of elastic material would tend to deteriorate more quickly as are result of becoming wet, which happens frequently during training of hunting dogs. The elastic strap material generally would tend to become brittle when subjected to low temperatures, and this would tend to make elastic collar straps that subjected to low temperatures more subject to partial or complete breakage.

Various straps composed of sections of a combination of leather and elastic material have been used as a cinch straps for saddles and for horse reins. U.S. Pat. Nos. 4,132,055, 4,434,604, 4,709,539, 6,349,527 and 6,571,541 are believed to be generally indicative of the state of the art for strap material including both elastic and non-elastic sections for use in animal training. However, it is believed that the combination of sections of elastic material and non-elastic material has never been used is a collar for supporting electronic stimulation and/or sensing devices on animals of any kind.

The present assignee is aware that a problem of its above-mentioned prior VICEBREAKER H1 equine remote trainer product of FIG. 1B is that the collar-mounted receiver unit 4 tends to rotate circumferentially around the horse's neck as a result of large (but normal) changes in the circumference and cross-sectional shape of a horse's neck that occur during various normal activities and also during cribbing activity, causing the leather collar 5 of receiver unit 4 to slide downward along the side of the horse's neck. This prevents the stimulus electrodes 6 from making adequate electrical contact to the horse's neck and therefore often prevents effective use of equine remote trainer 1.

When a horse having the prior VICEBREAKER H1 device with the all-leather collar strap 5 lowers its head enough to feed, the circumference of the horse's neck decreases to the point that the leather collar strap 5 becomes so loose that the receiver unit 4 sometimes “flips over” 180 degrees (thereby longitudinally twisting the leather collar strap 5). Usually, a horse indulges in cribbing activity with its head raised so as to be almost horizontal, and usually bites on fence rails and the like with its head in that raised position.

The prior VICEBREAKER devices usually are mounted on a horse's neck with its head in a resting or “neutral” position, and the non-elastic collar strap 5 almost always becomes loose or nearly loose when the horse's head is at a low feeding level and/or during cribbing behavior. Also, if the non-elastic collar strap 5 is tight enough to be snug when the horse's head is at a low feeding level or during cribbing, then when the horse raises its head to a neutral or high level the tension in the leather collar is enough or nearly enough to cause the buckle tongue member extending through the adjustment holes of the leather strap to tear the leather; also, the discomfort level to the horse might be very high and has been known to impair normal breathing.

Thus, there is an unmet need for an improved collar-mounted electronic animal stimulation and/or sensing device which avoids problems associated with normal changes in the circumference and/or shape of the neck of an animal during various activities.

There also is an unmet need for an improved collar-mounted equine stimulation and/or sensing device which avoids problems with stability of a collar-mounted aversive stimulus receiver and/or sensor unit associated with changes in the circumference or shape of the neck of a horse during various activities, including cribbing activities.

There also is an unmet need for an improved collar-mounted dog stimulation and/or sensing device which avoids problems with stability of a collar-mounted aversive stimulus receiver and/or sensor unit associated with changes in the circumference or shape of the dog's neck during normal activity.

### OBJECTS OF THE INVENTION

Accordingly, is an object of the invention to provide an improved collar-mounted electronic animal stimulation and/or sensing device which avoids problems associated with changes in the circumference or shape of the neck of an animal during various activities.

It is another object of the invention to provide an improved collar-mounted electronic animal stimulation and/or sensing device which maintains adequate or constant pressure of stimulus electrodes throughout the range of normal changes in the circumference or shape of the neck of an animal during various activities.

It is another object of the invention to provide an improved collar-mounted equine training device which avoids problems with the stability of prior collar-mounted stimulation and/or sensing devices associated with normal changes in the circumference or shape of the neck of a horse during various activities, including cribbing activities.

It is another object of the invention to provide an improved collar-mounted dog training device which avoids problems with the stability of a collar-mounted stimulation and/or sensing unit associated with changes in the circumference or shape of the dog's neck due to normal activity.

### SUMMARY OF THE INVENTION

Briefly described in the embodiment chosen for illustration, the animal training apparatus is a horse training apparatus including an electronic stimulus device having first and second stimulus electrodes for electrically contacting skin in an area on the side of a horse's neck. A partially elastic collar supports the electronic stimulus device so as to press conductive tips of the first and second stimulus electrodes against the skin. The partially elastic collar includes a non-elastic strap section having a free first end and a second end and an elastic strap section having a first end attached to the second end of the non-elastic strap section and a second end attached to a buckle. The elastic strap section stretches to accommodate changes in the circumference or shape of the horse's neck so as to maintain at least a minimum tensile force in the collar as the circumference of the horse's neck varies from a minimum to a maximum value as result of normal movement of horse's head to thereby hold the electronic stimulus device so as maintain pressure of the conductive tips against the skin.

### BRIEF DESCRIPTION OF THE DRAWINGS

The present invention may more readily be described by reference to the accompanying drawings in which:

FIG. 1A is a perspective view of an electronic animal training device supported in accordance with the teachings of the present invention.

FIG. 1B a perspective view showing the receiver of FIG. 1A properly mounted on a horse by means of a prior art collar.

FIG. 2 is a perspective view of the receiver of the equine remote trainer product of the present invention properly mounted on a horse by means of an improved collar of the present invention.

FIG. 3A is a perspective view of the composite leather and elastic mounting collar of the equine remote trainer shown in FIG. 2.

FIG. 3B is an outer plan view of the composite leather and elastic mounting collar of the equine remote trainer shown in FIG. 2.

FIG. 3C is a edge view of the composite leather and elastic mounting collar of the equine remote trainer shown in FIG. 2.

FIG. 3D is an inner plan view of the composite leather and elastic mounting collar of the equine remote trainer shown in FIG. 2.

FIG. 4 is a perspective you of another embodiment of invention including multiple elastic sections and multiple leather sections.

### DETAILED DESCRIPTION OF THE PREFERRED EMBODIMENTS

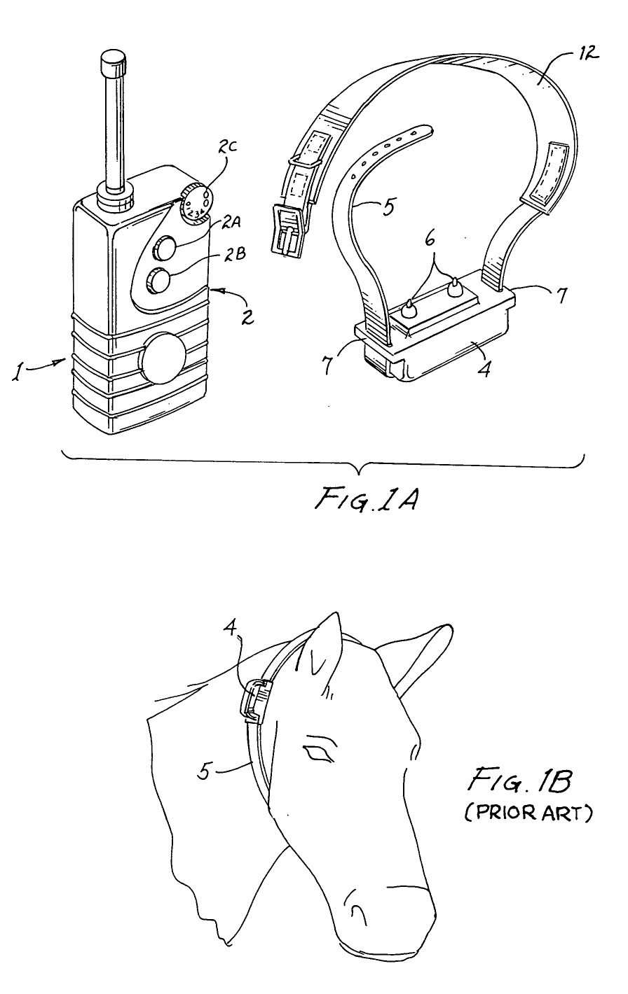

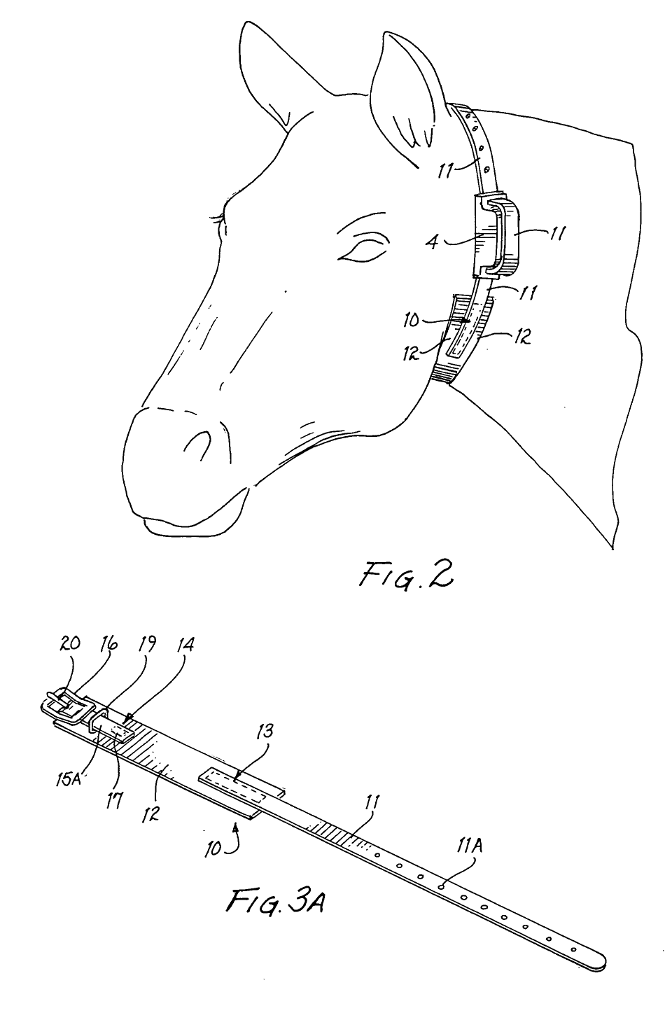

Referring to FIG. 2, the same receiver unit 4 shown in the above described FIGS. 1A and 1B is mounted on the neck of a horse by means of an improved collar 10 of the present invention.

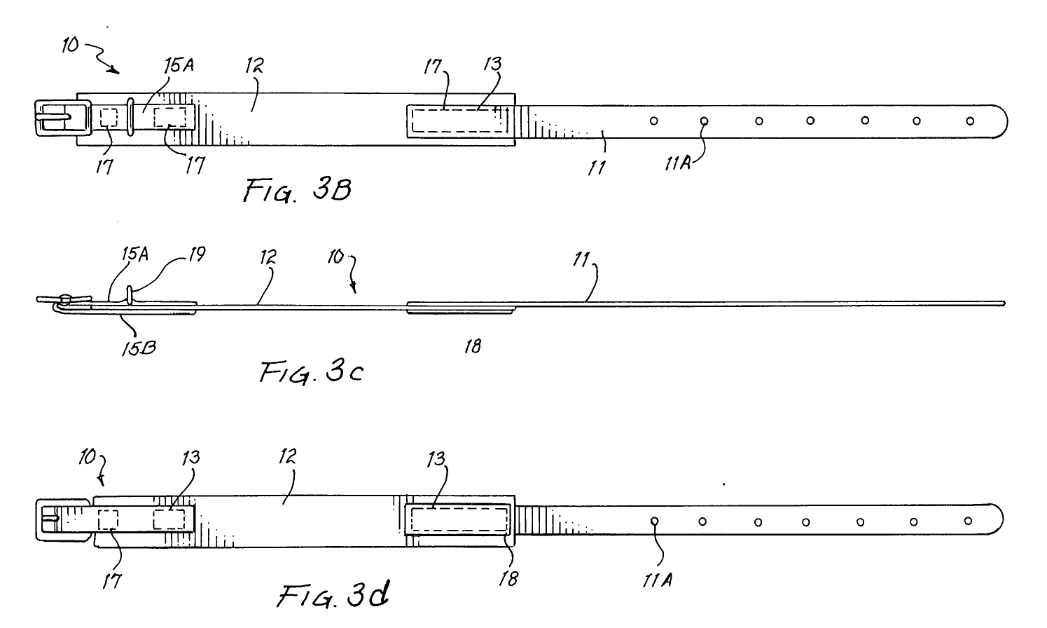

Referring to FIGS. 3A-3D, collar 10 includes a leather strap section 11 having a buckle tongue holes 11A therein for receiving the tongue member 20 of a buckle assembly 14. As illustrated, the left end of leather strap section 11 is attached by means of stitching 13 to the outer right end portion of an elastic strap section 12. A elongated short leather backing section 18 is aligned with the left end portion of leather strap section 11 and is attached to the inner right end portion of elastic strap section 12 by means of stitching 13. Backing section 18 is necessary for durability of stitching 13, as the strength of direct stitching to elastic material is inadequate.

Buckle assembly 14 is attached to the left end of elastic section 12 by means of two stitching sections 17. The buckle assembly 14 includes a leather buckle strap section 15A,B including an outer piece 15A and an inner piece 15B which are stitched by means of stitching 17 to the outer and inner left end surface portions, respectively, of elastic strap section 12. The left portions of leather buckle strap sections 15A and 15B form a small loop around a tongue-support bar (not shown) that is attached between the opposed side rails of a buckle frame 16. A tongue member 20 is pivotally mounted on the tongue-support bar and passes through a slot in the left end of buckle strap section 15A, 15B. A strap-retaining loop 19 extends around outer piece 15A between stitching sections 17. Of course, mechanical fastener means other than the illustrated buckle 17, such as hook-and-loop (Velcro®), clamps or multiple snaps can be used if more convenient. Similarly, the leather buckle strap section 15A and 15B could be modified to provide an extension to form a second leather strap similar to the leather strap section 11. This latter configuration would place the elastic section 12 between two leather strap sections; this configuration may be helpful in certain circumstances to facilitate the appropriate positioning of the elastic strap section and the receiver unit.

As indicated in FIG. 2, leather strap section 11 extends through the loops 7 (FIG. 1A) of receiver unit 4 to support it against the side of the horse's neck as shown in FIG. 2. Various other ways of engaging/supporting the receiver unit 4 by means of the strap section 11 may be used if more convenient.

In a commercial embodiment of the invention, leather strap section 11 is 23 inches in length and 1 inch in length, and approximately 0.1 inches thick and may be selected from an appropriate grade of leather. The buckle tongue-receiving holes 11A are spaced approximately 1.5 inches apart. Elastic strap section 12 preferably is composed of a woven flat elastic material, such as woven flat black elastic strap incorporated of 2/150 black polyester warp and filler and including 37 gauge elastomer; such material is commercially available from various sources. The length of elastic strap section 12 is 14 inches, and its width is 2 inches. The distance between the right end of strap section 15A and the right end of leather strap section 11 is 6 inches, and the right end of buckle strap section 15A is 3.75 inches from the left end of elastic strap section 12. The width of elastic strap sections 15A and 15B is 1 inch. The length of leather section 18 is approximately 4 inches and its width is 1 inch. The width of elastic strap 12 is wider than the width of leather strap 11 to stabilize collar 10 so as to prevent any longitudinal “twisting” of any portion of collar 10 in the event it becomes momentarily loosened as the horse lowers its head or engages in cribbing activity.

By measuring the diameter of a number of horses' necks with their heads lowered and also with their heads raised, it has been found that the circumference of a typical horse's neck can increase roughly 4 to 8 inches as the horse raises its head from a lowered position to an upper position. One purpose of collar 10 is to keep the conductive tips of stimulus electrodes 6 snug against the skin of side of the horse's neck in order to provide effective electrical contact thereto and hence provide aversive electrical stimulus.

However, if the leather collar strap 5 shown in the prior art device of FIG. 1B is put on the horse's neck when its head is elevated to a “neutral” or “resting” position, then effective electrical contact between the conductive tips of stimulus electrodes 6 and the skin of the horse's neck is lost when the horse lowers its head because the circumference of its neck is reduced by 4 to 8 inches.

Also, the leather collar 5 may rotate circumferentially about the horse's neck, causing the receiver unit 4 to slide lower along the side of horse's neck to the location of the jugular groove, at which electrical contact of the conductive tips of stimulus probes 6 with the skin is inadequate.

An important function of partially elastic collar 10 is to maintain consistent and suitable positioning and pressure of the electrode tips of stimulus electrodes 6 against the animal's skin so as to ensure consistent application of electrical stimulus. (The present assignee spent many years trying to solve problems in achieving consistent application of electrical stimulus from insulated stimulus electrodes in dog training products. Some of these problems are described in the assignee's previous patents.) Another important function of collar 10 is preventing rotation of the collar-supported electronic product on the horse's neck. For example, an elastic collar might be especially important in maintaining the position of a sensor, such as a microphone in a bark limiter product for use in dog training, or a cribbing activity sensing product, to effectively detect sounds produced in the throat of the horse.

The internal circuitry of stimulus receiver 4 is designed to produce selectable levels of stimulation within a range that is suitable for training of horses. That range is substantially lower than the range of levels of stimulation suitable for training of dogs, because horses are more sensitive to such electrical stimulus. The lower stimulus levels may result in less effective electrical contact between the tips of electrodes 6 and the adjacent skin on the side of the horse's neck. Therefore, it is very important that collar 10 consistently maintain adequate physical contact of stimulus electrodes 6 against the horse's skin.

Elastic strap section 12 can be composed of non-cotton-based material in order to avoid potential problems with premature rotting. The material of elastic strap section 12 must have sufficient “stretch” that when collar 10 is tightened to be sufficiently snug with the horse's head in a neutral or resting position, the elastic strap section 12 stretches to accommodate changes in the circumference of the horse's neck to maintain at least a minimum tensile force in collar 10 as the circumference of the horse's neck varies from a minimum to a maximum value as result of normal movement of the horse's head. This results in electronic stimulus device 4 being supported so that adequate pressure is maintained on electronic stimulus device 4 that the conductive tips of electrodes 5 maintain good electrical contact with the skin of the horse's neck. A considerable amount of experimentation was required to determine the type of material, length, thickness, width, and length of elastic strap section 12 needed to meet the above requirements and thereby solve the above-mentioned problems of the prior art.

A substantial portion of the 4 to 8 inch stretch range of the elastic section should be taken up when the collar 10 is mounted and tightened on the horse's neck with its head in a neutral position, because the neck diameter and circumference are close to maximum at that point.

In some cases, it may be advantageous to provide to multiple elastic sections 12 in collar 10 in order to provide different elastic sections with different amounts of elasticity, so that as the elastic limit of one elastic section is reached, another stronger elastic section can continue to stretch as needed. Also, in some cases it might be possible to use elastic material for most or all of the strap material of collar 10.

The market for horse-related strap products generally prefers or demands leather products, which have been time-proven to be superior for most applications. However, in some cases leather strap section 11 might be replaced by suitable vinyl coated plastic material such as Biothane® belting from BioPlastica Company located in Ridgeville, Ohio.

There is a relatively small but appreciable change in the circumference of the necks of “large” dogs. Although the neck circumference of such a large dog does not change nearly as much as the typical 4 to 8 inch change in the neck circumference of a typical horse, a modified embodiment of collar 10 may be useful in achieving the objective of maintaining constant force of stimulus electrodes 6 against the skin of the dog's neck to prevent the collar and stimulus and/or sensor unit (e.g., the microphone of a bark limiter device) from moving, especially if, for example, the dog learns ways of holding its head so as to reduce its neck size and thereby avoid the stimulus of a collar-supported electronic bark limiter electrical stimulus device.

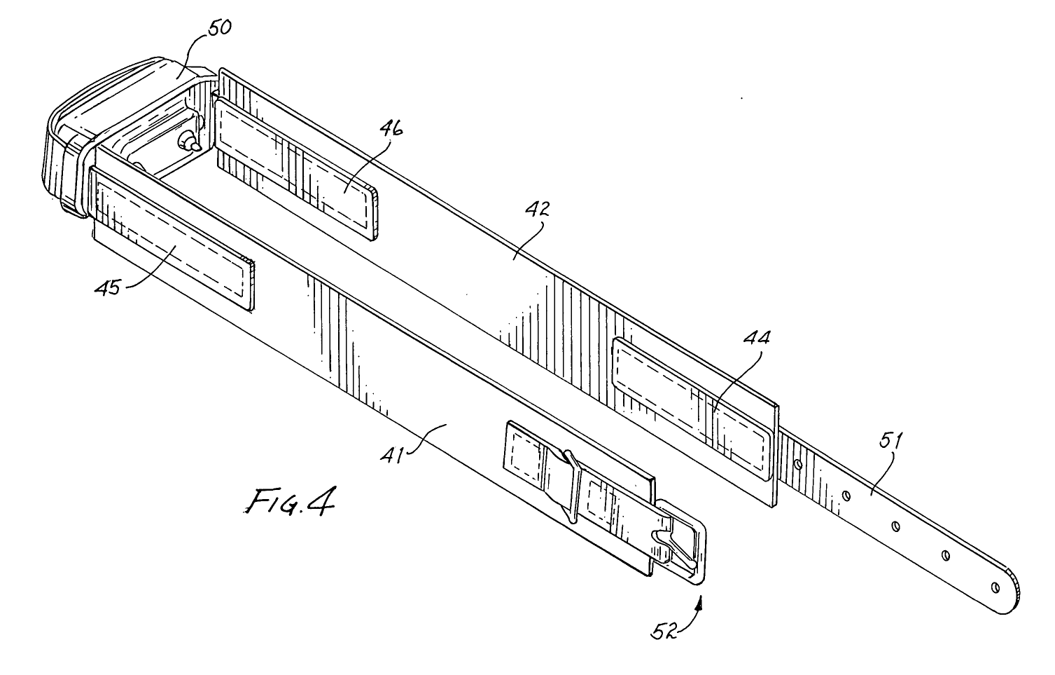

Referring to FIG. 4, an alternative embodiment of an electronic receiver unit is shown. The electronic receiving unit 50 is the same as the receiver unit 4 shown in connection with the previously described embodiment. However, the leather strap section 45 extending through loops provided in the receiver unit 50 is attached by stitching 46 to first and second elastic strap sections 41 and 42. Thus, the single elastic strap 12 of the previous embodiments has been replaced with two elastic strap sections 41 and 42. A second leather strap section 51 is secured to the second elastic strap section 42 through the utilization of a leather backing section 44 and stitching in a manner similar to that described in connection with the previous embodiments. Similarly, a buckle assembly 52 is secured to the first elastic strap section 41. It may be seen that the embodiment of FIG. 4 provides two independent elastic strap sections that provide increased extension capabilities to accommodate a greater range of the increase in horse neck circumference; further, the increased total length of the elastic strap portions of this embodiment may permit the utilization of different elastic materials whose modulus of elasticity may be varied to accommodate a wider variety of conditions encountered during use. Further, the elasticity of the respective elastic strap sections 41 and 42 may be chosen to be different such that one section will elongate under a predetermined stretching force up to its designed limit while the second elastic strap section, having a different modulus of elasticity, will begin significant “stretching” only after the first elastic section has been extended to its limit.

While the invention has been described with reference to several particular embodiments thereof, those skilled in the art will be able to make various modifications to the described embodiments of the invention without departing from its true spirit and scope. It is intended that all elements or steps which are insubstantially different from those recited in the claims but perform substantially the same functions, respectively, in substantially the same way to achieve the same result as what is claimed are within the scope of the invention. For example, receiver unit 4 could be either a sensing device or a stimulus device or a combination of the two, rather than the electronic stimulus device 4 as described. Similarly, the electronic stimulus device 4 can be a transmitter, receiver, transceiver, an audio device to emit selected sounds for command/training, or a vibrator to transmit vibrational sensations to the animal upon which the device is mounted.

What is claimed is:

1. An animal training apparatus comprising:
(a) a collar-supported electronic device positioned against the neck of an animal to be trained;
(b) a partially elastic collar for holding the electronic device against a neck of an animal to be trained, the partially elastic collar including
i. a non-elastic strap section having a first end and a second end,
ii. an elastic strap section having a first end attached to the second end of a non-elastic strap section and a second end attached to a fastening means, wherein the elastic strap section stretches to accommodate changes in the circumference of the neck so as to maintain at least a minimum tensile force in the collar as the circumference of the neck varies from a minimum to a maximum value as a result of normal movement of the animal's head.

2. An animal training apparatus comprising:
(a) a collar-supported electronic device having electrodes positioned against the neck of an animal to be trained;
(b) a partially elastic collar for holding the electronic device so as to press said electrodes against a neck of an animal to be trained, the partially elastic collar including
i. a non-elastic strap section having a first end and a second end,
ii. an elastic strap section having a first end attached to the second end of a non-elastic strap section and a second end attached to a fasten means, wherein the elastic strap section stretches to accommodate changes in the circumference of the neck so as to maintain at least a minimum tensile force in the collar as the circumference of the neck varies from a minimum to a maximum value as a result of normal movement of the animal's head.

3. A horse training apparatus comprising:
(a) an electronic stimulus device having first and second stimulus electrodes for electrically contacting skin in an area on the side of a horse's neck; and
(b) a partially elastic collar for holding the electronic stimulus device so as to press conductive tips of the first and second stimulus electrodes against the skin, the partially elastic collar including
i. a non-elastic strap section having a free first end and a second end,
ii. an elastic strap section having a first end attached to the second end of the non-elastic strap section and a second end attached to a fastening means,
wherein the elastic strap section stretches to accommodate changes in the circumference of the horse's neck so as to maintain at least a minimum tensile force in the collar as the circumference of the horse's neck varies from a minimum to a maximum value as result of normal movement of horse's head to thereby hold the electronic stimulus device so as maintain pressure of the conductive tips against the skin.

4. The animal training apparatus of claim 1 wherein said fastening means is a buckle.

5. The animal training apparatus of claim 2 wherein said fastening means is a buckle.

6. An animal training apparatus comprising:
(a) a collar-supported electronic device for use in training an animal;
(b) a buckle having a buckle tongue;
(c) a collar including a non-elastic strap secured to said electronic device and extending therefrom to terminate in a free end having buckle tongue holes therein, said non-elastic strap having a second end;
(d) an elastic strap having one end secured to the second end of said non-elastic strap, and having another end secured to said buckle
wherein said elastic strap stretches to accommodate changes in required collar length to maintain a minimum tensile force in the collar and thereby maintain a desired position of the electronic device on the animal.

7. The animal training apparatus of claim 6 wherein said electronic device includes stimulus electrodes for contacting the animal's skin.

8. An animal training apparatus comprising:
(a) a collar-supported electronic device for use in training said animal, said collar including
i. a non-elastic strap secured to said electronic device and extending therefrom and terminating in first and second ends,
ii. a first elastic strap secured to the first end of said non-elastic strap and having an opposite end,
iii. a second elastic strap secured to the second end of said non-elastic strap and having an opposite end,
iv. fastening means for securing said opposite ends together.

9. The animal training apparatus of claim 9 wherein said fastening means is a buckle.

10. The animal training apparatus of claim 8 wherein said first and second elastic straps each have a different modulus of elasticity.
